(19) United States
(12) Patent Application Publication
(10) Pub. No.: US 2018/0328557 A1
(43) Pub. Date: Nov. 15, 2018

(54) OPTICAL DEVICE

(71) Applicant: PANASONIC INTELLECTUAL PROPERTY MANAGEMENT CO., LTD., Osaka (JP)

(72) Inventors: Kazuki KITAMURA, Osaka (JP); Norihiro ITO, Osaka (JP); Hirofumi KUBOTA, Osaka (JP); Masuyuki OTA, Osaka (JP)

(73) Assignee: PANASONIC INTELLECTUAL PROPERTY MANAGEMENT CO., LT D., Osaka (JP)

(21) Appl. No.: 15/775,571

(22) PCT Filed: Nov. 4, 2016
(86) PCT No.: PCT/JP2016/004809

§ 371 Date: May 11, 2018

(30) Foreign Application Priority Data
Dec. 8, 2015 (JP) 2015-239768

(51) Int. Cl. F21S 11/00; E06B 3/67; E06B 9/24; G02F 1/29; F21V 14/00

(52) U.S. Cl. CPC F21S 11/007; E06B 3/6715; E06B 9/24; B32B 7/12; F21V 14/003; E06B 2009/2417; G02F 1/29

(57) ABSTRACT

An optical device includes a first substrate having light transmission properties, a second substrate opposing the first substrate and having light transmission properties, and an optical control layer disposed between the first substrate and the second substrate and including a first light-transmitting portion that includes an optical medium and an uneven structure and a second light-transmitting portion that includes only the optical medium out of the optical medium and the uneven structure. The optical medium and the uneven structure have different refractive indices. In a plan view, the first light-transmitting portion and the second light-transmitting portion are repeatedly arranged in one direction, and the area of repetition of at least one of the first light-transmitting portion and the second light-transmitting portion varies in the one direction.

### TECHNICAL FIELD

The present invention relates to an optical device.

### BACKGROUND ART

Optical devices have been proposed that change the direction of travel of extraneous light incident from outside a room, such as sunlight, and guiding the extraneous light to the interior of the room.

For example, Patent Literature (PTL) 1 discloses a lighting film that is stuck to a window in order to change the direction of travel of incident sunlight and to guide the sunlight to the interior of a room. The lighting film disclosed in PTL 1 includes a first base material, a plurality of lighting portions, a first bonding layer, a second base material, a second bonding layer, and a light scattering layer. The lighting film causes light with a reduced glare to be applied to, for example, a ceiling surface in the room by totally reflecting light incident on the lighting portions at lower side surfaces of the lighting portions to direct the light obliquely upward or by scattering the light in the light scattering layer.

PTL 2 discloses a lighting film that is placed on a window in order to change the direction of travel of incident sunlight and guide the sunlight to a ceiling surface in the room. The lighting sheet disclosed in PTL 2 has a reflective surface generated by filling a filler in hollow grooves formed in a transparent sheet material, and reflects the sunlight at the reflective surface so as to bend the optical path of the sunlight and apply the sunlight to, for example, the ceiling surface in the room.

### CITATION LIST

PTL 1: WO 2015/056736

PTL 2: Japanese Unexamined Patent Application Publication No. 2012-255951

### SUMMARY OF THE INVENTION

### Technical Problem

Conventional optical devices can improve room illuminance by bending extraneous light such as sunlight and applying the light to the ceiling surface in the room. This allows lighting fixtures in the room to be turned off or to output less light, thus achieving power savings.

The conventional optical devices, however, have a problem in they cannot offer an outside view from inside a room when applying extraneous light to the ceiling surface, i.e., when controlling light distribution to bend extraneous light. In particular, the optical device according to PTL 1 becomes like milky glass due to constant light scattering in the light scattering layer and therefore cannot offer an outside view from inside a room.

In this way, the conventional optical devices lose their original function of offering an outside view as windows, although they can brighten the interior of the room. In addition, the inability to see the outside view gives people in the room a feeling of being closed in.

The present invention has been made in light of the problem described above, and it is an object of the present invention to provide an optical device capable of offering an outside view from inside a room while distributing extraneous light and letting the light into the room.

### Solution to Problem

In order to achieve the object described above, an optical device according to an aspect of the present invention includes a first substrate having light transmission properties, a second substrate opposing the first substrate and having light transmission properties, and an optical control layer disposed between the first substrate and the second substrate and including a first light-transmitting portion and a second light-transmitting portion, the first light-transmitting portion including an optical medium and an uneven structure, and the second light-transmitting portion including only the optical medium out of the optical medium and the uneven structure. The optical medium and the uneven structure have different refractive indices. When viewed in a plan view, the first light-transmitting portion and the second light-transmitting portion are repeatedly arranged in one direction, and an area of repetition of at least one of the first light-transmitting portion and the second light-transmitting portion varies in the one direction.

### Advantageous Effect of Invention

According to the present invention, the optical device can offer an outside view from inside a room while distributing extraneous light and letting the light into the room.

### BRIEF DESCRIPTION OF DRAWINGS

FIG. 1 is a plan view of an optical device according to Embodiment 1.

FIG. 2 is an enlarged perspective view schematically illustrating part of the optical device according to Embodiment 1.

FIG. 3A is a cross-sectional view of a first light-transmitting portion of an optical control layer in the optical device according to Embodiment 1.

FIG. 3B is a cross-sectional view of a second light-transmitting portion of the optical control layer in the optical device according to Embodiment 1.

FIG. 4 illustrates an example of use of the optical device according to Embodiment 1.

FIG. 5A is a cross-sectional view of the first light-transmitting portion of the optical control layer in an optical device according to Variation 1 of Embodiment 1.

FIG. 5B is a cross-sectional view of the second light-transmitting portion of the optical control layer in the optical device according to Variation 1 of Embodiment 1.

FIG. 6A is a cross-sectional view of the first light-transmitting portion of the optical control layer in an optical device according to Variation 2 of Embodiment 1.

FIG. 6B is a cross-sectional view of the second light-transmitting portion of the optical control layer in the optical device according to Variation 2 of Embodiment 1.

FIG. 7A is a cross-sectional view of the first light-transmitting portion of the optical control layer in an optical device according to Embodiment 2.

FIG. 7B is a cross-sectional view of the second light-transmitting portion of the optical control layer in the optical device according to Embodiment 2.

FIG. 8 illustrates an example of rise of the optical device according to Embodiment 2.

FIG. 9 is a cross-sectional view of the first light-transmitting portion of the optical control layer in an optical device according to a first variation.

FIG. 10A is a cross-sectional view of the first light-transmitting portion of the optical control layer in an optical device according to a second variation.

FIG. 10B is a cross-sectional view of the second light-transmitting portion of the optical control layer in the optical device according to the second variation.

FIG. 11A is a cross-sectional view of the first light-transmitting portion of the optical control layer in an optical device according to a third variation.

FIG. 11B is a cross-sectional view of the second light-transmitting portion of the optical control layer in the optical device according to the third variation.

FIG. 12 is a cross-sectional view of the first light-transmitting portion of the optical control layer in an optical device according to a fourth variation

FIG. 13 is a cross-sectional view of the first light-transmitting portion of the optical control layer in an optical device according to a fifth variation.

### DESCRIPTION OF EXEMPLARY EMBODIMENTS

Embodiments of the present invention will be described hereinafter. Each embodiment described below shows a preferable specific example of the present invention. Thus, numerical values, shapes, materials, constituent elements, arrangement and connection forms of constituent elements, and so on given in the following embodiments are merely examples and are not intended to limit the present invention. Among the constituent elements in the following embodiments, those that are not recited in any one of the independent claims, which represent the broadest concept of the present invention, are described as optional constituent elements.

Note that each drawing is a schematic diagram and does not always strictly follow the actual configuration. Thus, the scale and so on in each drawing do not always match those in the other drawings. In the drawings, constituent elements that are substantially identical are given the same reference marks, and redundant descriptions thereof are omitted or simplified.

In the specification and drawings of the present invention, X, Y, and Z axes represent three axes in a three-dimensional orthogonal coordinate system. In embodiments of the present invention, the Z axial direction is taken as a vertical direction, and directions perpendicular to the Z axis (i.e., directions parallel to an XY plane) are taken as horizontal directions. The X and Y axes are orthogonal to each other and are both orthogonal to the Z axis. Note that the plus Z axial direction is taken as a vertical downward direction. In the specification of the present invention, a “thickness direction” refers to a direction along the thickness of the optical device, i.e., a direction perpendicular to the main surfaces of first and second substrates, and a “plan view” refers to a view seen from a direction perpendicular to the main surface of first substrate 10 or second substrate 20.

### Embodiment 1

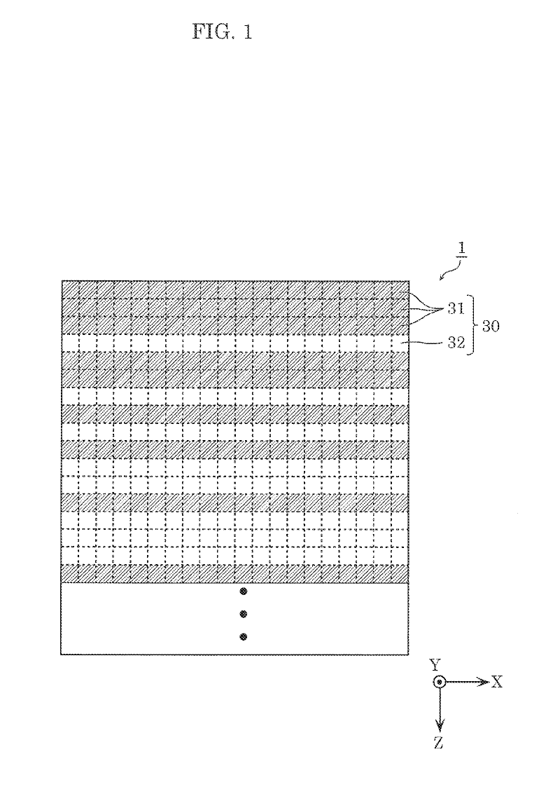

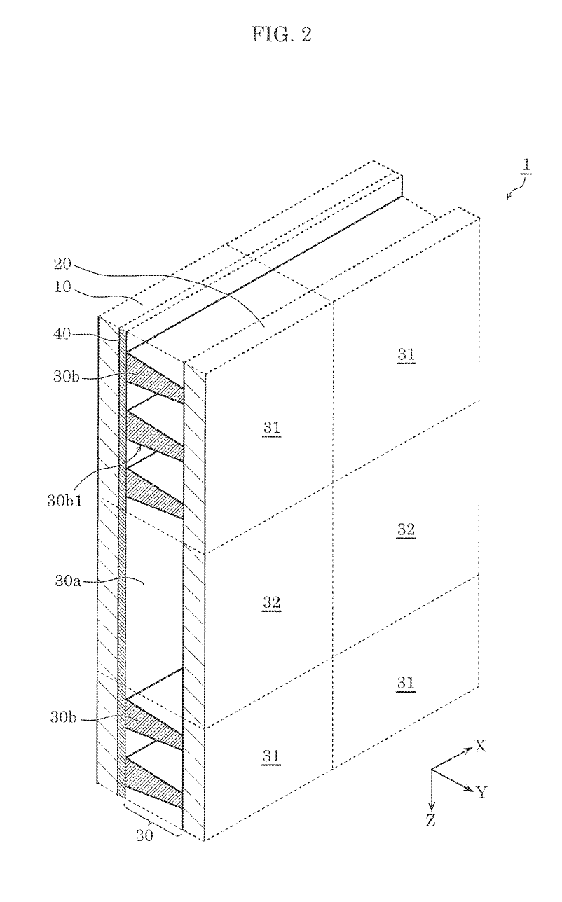

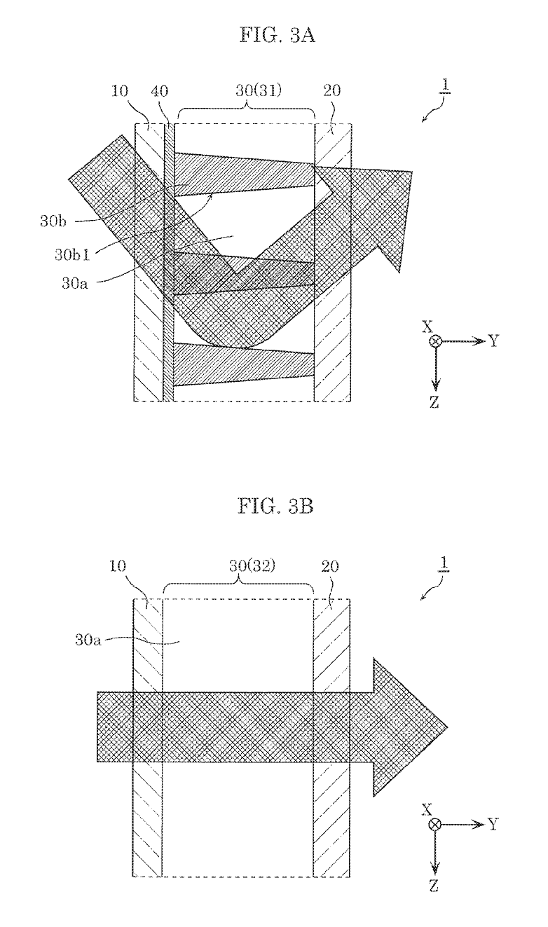

First, an overall configuration of optical device 1 according to Embodiment 1 will be described with reference to FIGS. 1, 2, 3A, and 3B. FIG. 1 is a plan view of optical device 1 according to Embodiment 1 when viewed from the direction perpendicular to the main surface of first substrate 10. FIG. 2 is an enlarged perspective view schematically illustrating part of optical device 1. FIG. 3A is a cross-sectional view of first light-transmitting portion 31 of optical control layer 30 in optical device 1, and FIG. 3B is a cross-sectional view of second light-transmitting portion 32 of optical control layer 30 in optical device 1.

As illustrated in FIGS. 1 to 3B, optical device 1 is an optical control device that controls light incident on optical device 1 and includes first substrate 10, second substrate 20, and optical control layer 30. Optical device 1 further includes contact layer 40 formed on the surface of first substrate 10 that faces optical control layer 30.

First substrate 10 and second substrate 20 are light transmissible substrates having light transmission properties. As illustrated in FIG. 1, first substrate 10 and second substrate 20 have, for example, a rectangular shape such as a square or a rectangle in a plan view. The shape of the first and second substrates is, however, not limited to a rectangular shape and may be a circular shape or a polygonal shape other than a square, i.e., any shape is adoptable.

As illustrated in FIGS. 2, 3A, and 3B, second substrate 20 is a counter substrate that faces first substrate 10, and is disposed at a position opposing first substrate 10. First substrate 10 and second substrate 20 may be bonded together with a seal resin such as an adhesive formed in a frame-like shape along the outer peripheries of the edges of the substrates.

First substrate 10 and second substrate 20 may for example be glass substrates or resin substrates. Examples of the material for glass substrates include soda-lime glass, no alkali glass, and high refractive glass. Examples of the material for resin substrates include resin materials such as polyethylene terephthalate (PET), polyethylene naphthalate (PEN), polycarbonate, acrylic, and epoxy. Glass substrates have the advantages of high light transmittance (transparency) and low moisture permeability On the other hand, resin substrates have the advantage of less scattering during breakage. First substrate 10 and second substrate 20 may be made of the same material or different materials, but they are preferably made of the same material. First substrate 10 and second substrate 20 are not limited to rigid substrates and may be flexible substrates having flexibility.

As illustrated in FIGS. 3A and 3B, optical control layer 30 is disposed between first substrate 10 and second substrate 20. Optical control layer 30 has light transmission properties and controls light that passes therethrough. Optical control layer 30 includes first light-transmitting portion 31 and second light-transmitting portion 32 as illustrated in FIGS. 1 to 3B.

In order to facilitate understanding of the size (area) of each of first light-transmitting portion 31 and second light-transmitting portion 32, FIGS. 1 and 2 illustrate each of first light-transmitting portion 31 and second light-transmitting portion 32 as a region that is configured by a combination of a plurality of unit regions (regions surrounded by broken lines), each unit region being a square region in a plan view. In FIG. 1, regions corresponding to first light-transmitting portions 31 are cross-hatched, and regions corresponding to second light-transmitting portions 32 are left blank.

As illustrated in FIG. 3A, first light-transmitting portion 31 of optical control layer 30 is a region that includes optical medium 30a and uneven structure 30b. In first light-transmitting portion 31, optical medium 30a and uneven structure 30b are in contact with each other. On the other hand, second light-transmitting portion 32 of optical control layer 30 is a region that includes only optical medium 30a, out of optical medium 30a and uneven structure 30b, as illustrated in FIG. 3B.

Optical medium 30a transmits light incident on optical device 1 from first substrate 10 to second substrate 20. In the present embodiment, optical medium 30a is air.

Irregular structure (uneven construct) 30b is configured by a plurality of projections 30b1 of micro- or nano-order size. Each projection 30b1 is formed in a stripe shape. Specifically, projections 30b1 have the same shape and are aligned at equal intervals in the Z axial direction. Each projection 30b1 has an approximately quadrangular prism shape that is long and trapezoidal in cross section. Although projections 30b1 are arranged with clearance between their roots and therefore adjacent projections 30b1 are not in contact with each other, the present invention is not limited to this example. For example, projections 30b1 may be arranged with no clearance between their roots (i.e., with no intervals) so that adjacent projections 30b1 are in contact with each other. Although projections 30b1 are formed in a long shape across a plurality of unit regions of first light-transmitting portion 31 in the X axial direction and the number of projections 30b1 is three, the present invention is not limited to this example.

The material for uneven structure 30b may for example be a resin material having light transmission properties such as an acrylic resin, an epoxy resin, or a silicone resin irregular structure 30b may be formed by, for example, molding or nanoimprinting.

In optical control layer 30, optical medium 30a and uneven structure 30b have different refractive indices. In the present embodiment, optical medium 30a is air with a refractive index of 1.0, and uneven structure 30b is an acrylic resin with a refractive index of 1.5.

In optical device 1 having this configuration, first light-transmitting portion 31 and second light-transmitting portion 32 are repeatedly arranged in one direction in a plan view as illustrated in FIG. 1. That is, the one direction is the direction of repetition of first light-transmitting portion 31 and second light-transmitting portion 32. In the present embodiment, the Z axial direction is taken as the one direction, and a plurality of first light-transmitting portions 31 and a plurality of second light-transmitting portions 32 are alternately and repeatedly arranged in the Z axial direction.

In optical device 1, the area of repetition of at least one of first light-transmitting portion 31 and second light-transmitting portion 32 varies in the one direction (the direction of repetitions of first light-transmitting portion 31 and second light-transmitting portion 32) in a plan view.

In the present embodiment in which the one direction is the Z axial direction, the area of repetition of first light-transmitting portion 31 varies and the area of repetition of second light-transmitting portion 32 does not vary until in the midst of the Z axial direction, and from that point on in the Z axial direction, the area of repetition of second light-transmitting portion 32 varies and the area of repetition of first light-transmitting portion 31 does not vary, as illustrated in FIG. 1.

Thus, the ratio of the area of first light-transmitting portion 31 to the total area of first and second light-transmitting portions 31 and 32 in a cycle consisting of one first light-transmitting portion 31 and one second light-transmitting portion 32 varies in the one direction (the direction of repetition of first light-transmitting portion 31 and second light-transmitting portion 32) in a plan view.

Optical Action of Optical Device

Next, optical actions of optical device 1 (optical control layer 30) according to Embodiment 1 will be described with reference to FIGS. 3A and 3B.

Optical device 1 is capable of transmitting light. In the present embodiment, first substrate 10 is a substrate on the light incident side, and second substrate 20 is a substrate on the light exit side. Thus, optical device 1 is capable of transmitting light incident from first substrate 10 and emitting the light from second substrate 20. Specifically, the light incident from first substrate 10 is transmitted through first substrate 10, contact layer 40, optical control layer 30, and second substrate 20 in this order and emitted from second substrate 20 to the outside.

The light incident on optical device 1 undergoes optical actions when passing through optical control layer 30. In this case, the light incident on optical control layer 30 undergoes different optical actions when passing through first light-transmitting portion 31 and when passing through second light-transmitting portion 32, because first and second light-transmitting portions 31 and 32 of optical control layer 30 have different configurations.

Specifically, first light-transmitting portion 31 is configured by optical medium 30a and uneven structure 30b with different refractive indices as illustrated in FIG. 3A, and is capable of controlling the distribution of light incident on first light-transmitting portion 31. In the present embodiment, the light incident on first light-transmitting portion 31 is bent by first light-transmitting portion 31. That is, the light incident on first light-transmitting portion 31 is distributed by first light-transmitting portion 31, changes its travel direction in first light-transmitting portion 31, and passes through first light-transmitting portion 31.

Specifically, since optical medium 30a has a refractive index of 1.0 and uneven structure 30b has a refractive index of 1.5, total reflection of light occurs when the light is incident from uneven structure 30b to optical medium 30a. That is, the lower side surface of each projection 30b1 of uneven structure 30b serves as a totally reflecting surface. Thus, for example as illustrated in FIG. 3A, light that is incident at an angle greater than or equal to the critical angle on the lower side surfaces in uneven structure 30b, out of the light incident obliquely downward on first light-transmitting portion 31, is totally reflected by projections 30b1 of uneven structure 30b, changes its travel direction, and travels obliquely upward. That is, when optical device 1 is viewed from second substrate 20, a region corresponding to first light-transmitting portion 31 is a region that distributes light.

On the other hand, second light-transmitting portion 32 is configured by only optical medium 30a and includes no uneven structure 30b as illustrated in FIG. 3B. Thus, the light incident on second light-transmitting portion 32 travels as-is in straight lines without being controlled to be distributed and bent by second light-transmitting portion 32. Accordingly, the light incident on second light-transmitting portion 32 travels in straight lines and passes through second light-transmitting portion 32 without changing its travel direction. That is, when optical device 1 is viewed from second substrate 20, a region corresponding to second light-transmitting portion 32 is a transparent region.

Example of Use and Advantageous Effects of Optical Device

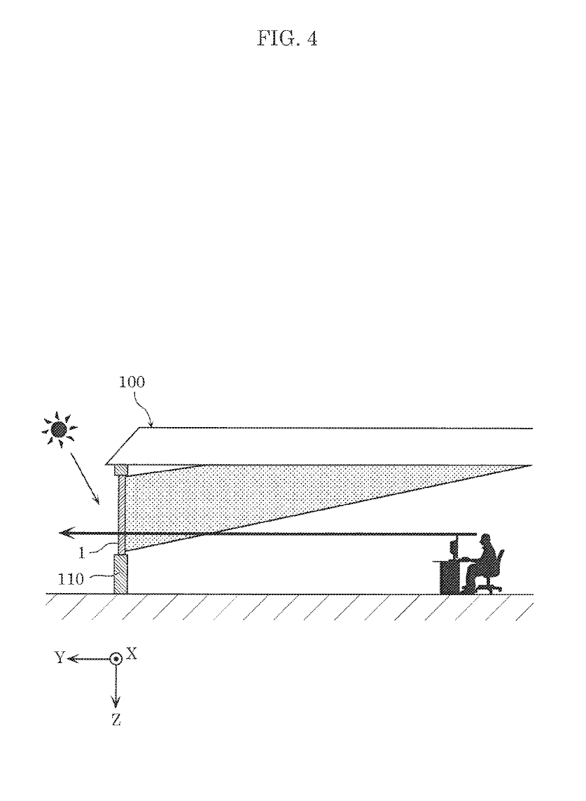

Next, an example of use of optical device 1 according to Embodiment 1. will be described with reference to FIG. 4. FIG. 4 illustrates an example of use of optical device 1 according to Embodiment 1.

As illustrated in FIG. 4, optical device 1 can be used as, for example, a window of building 100. Specifically, optical device 1 can be attached to an opening of exterior wail 110 of building 100. In this case, optical device 1 is mounted in a posture in which the main surface of first substrate 10 is parallel to the vertical direction (Z axial direction), i.e., in an upright posture.

Although a detailed structure of optical device 1 is not shown in FIG. 4, optical device 1 is disposed such that first substrate 10 is on the outside of the room and second substrate 20 is on the inside of the room.

In optical device 1, a plurality of first light-transmitting portions 31 that include uneven structure 30b and a plurality of second light-transmitting portions 32 that include no uneven structure 30b are repeatedly arranged in the vertical direction as illustrated in FIG. 1.

Thus, sunlight that is incident on first light-transmitting portions 31 out of the light incident on optical device 1 is totally reflected by uneven structure 30b of first light-transmitting portions 31 and guided to the ceiling inside the room. That is, sunlight that is incident obliquely downward on optical device 1 from obliquely upward is bent in a rebound direction (return direction) by uneven structure 30b. This allows sunlight to be applied to the ceiling inside the room as illustrated in FIG. 4, thus improving room illuminance. That is, the interior of the room can be brightened by distributing sunlight by first light-transmitting portions 31.

Optical device 1 further includes second light-transmitting portions 32 that do not include uneven structure 30b. Thus, sunlight that is incident on second light-transmitting portions 32 out of the light incident on optical device 1 travels in straight lines and enters the room without being bent by second light-transmitting portions 32. Accordingly, a person in the room is able to see an outside view from inside the room through second light-transmitting portions 32 as illustrated in FIG. 4.

Besides, the area of repetition of first light-transmitting portion 31 varies in the vertical direction as illustrated in FIG. 1. Specifically, the ratio of the area of first light-transmitting portion 31 to the total area of first and second light-transmitting portions 31 and 32 in a cycle consisting of one first lit-transmitting portion 31 and one second light-transmitting portion 32 varies in the vertical direction in a plan view. That is, the ratio of the area of first light-transmitting portion 31 changes by gradation, and the ratio of the area of first light-transmitting portion 31 increases toward the upper part of the optical device in the vertical direction.

Accordingly, the ratio of the light bent by first light-transmitting portions 31 is large in the upper part of optical device 1, and the ratio of the area that offers an outside view from inside the room is large in the lower part of optical device 1.

Summary

With Optical device 1 according to the present embodiment described above, when viewed in a plan view, first light-transmitting portion 31 and second light-transmitting portion 32 are repeatedly arranged in the one direction (Z axial direction in the present embodiment), and the area of repetition of first light-transmitting portion 31 varies in the one direction (Z axial direction in the present embodiment).

This configuration allows part of the light incident on optical device 1 to be controlled to be distributed and transmitted by first light-transmitting portion 31 and allows the other part of the light incident on optical device 1 to be transmitted without being controlled to be distributed by second light-transmitting portions 32. Besides, since the area of repetition of first light-transmitting portion 31 varies in the one direction, it is possible to change the ratio of light that is controlled to be distributed and the ratio of light that is not controlled to be distributed.

Thus, optical device 1, when used as for example a window as illustrated in FIG. 4, can offer an outside view from inside the room while controlling the distribution of extraneous light such as sunlight and letting the light into the room. This enables a person in the room to see an outside view even if sunlight is bent and applied to the ceiling surface. Accordingly, the optical device can brighten the interior of the room while maintaining its original function of offering an outside view as a window (transparency and openness).

In the present embodiment, the ratio of the area of first light-transmitting portion 31 to the total area of first and second light-transmitting portions 31 and 32 in a cycle consisting of one first light-transmitting portion 31 and one second light-transmitting portion 32 varies in the vertical direction in a plan view. This ratio increases toward the upper part of optical device 1 in the vertical direction when optical device 1 is disposed with the main surface of first substrate 10 being parallel to the vertical direction. That is, the ratio of the region where uneven structure 30b exists increases toward the upper part of the optical device in the vertical direction.

Accordingly, the ratio of the light controlled to be distributed by first light-transmitting portion 31 is large in the upper part of optical device 1, and the ratio of the area that offers an outside view from inside the room through second light-transmitting portion 32 is large in the lower part of optical device 1. Thus, when optical device 1 is used as a window, the upper part of the window has a greater ratio of light that is controlled to be distributed, and the lower part of the window has higher transparency. Accordingly; it is possible to brighten the room while increasing transparency at a position at the level of eyes of a person in the room. As a result, the interior of the room can be brightened with improved openness achieved by original transparency of the window.

In the present embodiment, optical medium 30a is air.

Thus, optical device 1 can be achieved with a simple configuration.

In the present embodiment, uneven structure 30b is configured by a plurality of projections 30b1, and each projection 30b1 has a trapezoidal cross-sectional shape.

Thus, optical device 1 can be achieved with a simpler configuration.

In the present embodiment, projections 30b1 are formed in a stripe shape,

Thus, optical device 1 can be achieved with a simple configuration.

Variation 1 of Embodiment 1

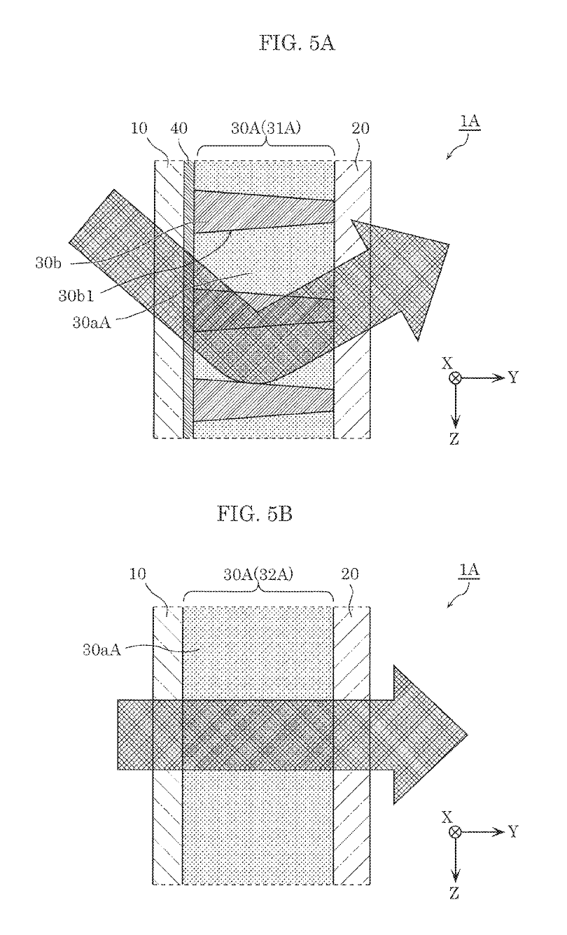

FIGS. 5A and 5B illustrate a configuration of optical device 1A according to Variation 1 of Embodiment 1. FIG. 5A is a cross-sectional view of first light-transmitting portion 31A of optical control layer 30A in optical device 1A, and FIG. 5B is a cross-sectional view of second light-transmitting portion 32A of optical control layer 30A in optical device 1A.

Although optical device 1 according to Embodiment 1 described above uses air as optical medium 30a of first light-transmitting portion 31 and second light-transmitting portion 32, optical device 1A according to this variation uses a resin having light transmission properties as optical medium 30aA of first light-transmitting portion 31A and second light-transmitting portion 32A. This resin may be a hard resin such as an acrylic resin, or may be a soft or liquid resin.

Optical medium 30aA and uneven structure 30b according to this variation also have different refractive indices. Specifically, optical medium 30aA may be a resin having a refractive index of 1.5 or less, e.g., a resin having a refractive index of 1.3. Alternatively, optical medium 30aA may be a resin having a refractive index greater than 1.5, e.g., a resin having a refractive index of 1.7. Irregular structure 30b is made of a resin having a refractive index of 1.5 as in Embodiment 1 described above.

As described above, optical device 1A according to this variation has a configuration similar to that of optical device 1 according to Embodiment 1 described above, and therefore achieves an effect similar to that of optical device 1 according to Embodiment 1 described above.

Specifically, the optical device is capable of offering an outside view from inside the room even if sunlight is bent and applied to the ceiling surface. Thus, the optical device can brighten the interior of the room while maintaining its original function of offering an outside view as a window(transparency and openness).

Besides, optical medium 30a A according to this variation is made of a resin. This allows uneven structure 30b to be protected from moisture, oxygen, and so on in the air, thus suppressing deterioration of uneven structure 30b. Accordingly, excellently reliable optical device 1A can be achieved.

Variation 2 of Embodiment 1

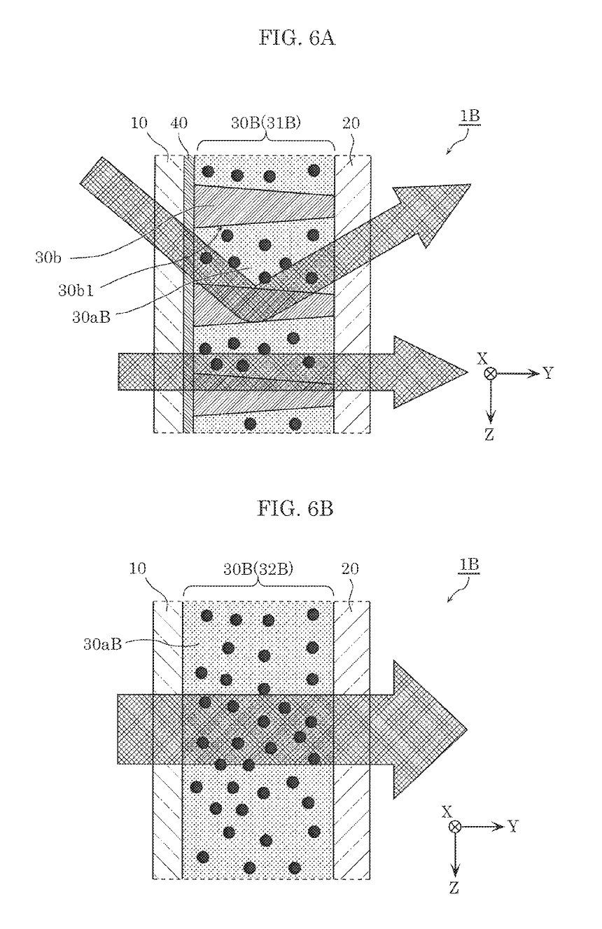

FIGS. 6A and 6B illustrate a configuration of optical device 1B according to Variation 2 of Embodiment 1. FIG. 6A is a cross-sectional view of first light-transmitting portion 31B of optical control layer 30B in optical device 1B, and FIG. 6B is a cross-sectional view of second light-transmitting portion 32B of optical control layer 30B in optical device 1B.

Although optical device 1 according to Embodiment 1 described above uses air as optical medium 30a of first light-transmitting portion 31 and second light-transmitting portion 32, optical device 1B according to the present variation uses a material that exhibits birefringence and electric field responsiveness as optical medium 30aB of first light-transmitting portion 31B and second light-transmitting portion 32B. The material for optical medium 30aB may be a liquid crystal. In the present embodiment, a positive liquid crystal is used as optical medium 30aB, the positive liquid crystal including rod-like liquid crystal molecules having a high dielectric constant in the major axial direction and a low dielectric constant in a direction perpendicular to the major axis.

In the case of using a positive liquid crystal, the rod-like liquid crystal molecules are oriented in a direction parallel to a direction orthogonal to the thickness direction of optical device 1B. That is, the liquid crystal molecules are oriented horizontally with respect to the main surfaces of first substrate 10 and second substrate 20.

Note that the liquid crystal molecules are known to be oriented along the shape of uneven structure 30b. Thus, it is favorable to form an alignment layer on the surface of uneven structure 30b and perform a rubbing process. This allows the liquid crystal molecules to be oriented horizontally with respect to the main surfaces of first substrate 10 and second substrate 20. It is also favorable to form an alignment layer on second substrate 20 and perform a rubbing process. This allows the liquid crystal molecules to be oriented horizontally across the entire region.

Optical medium 30aB and uneven structure 30b according to this variation also have different refractive indices. Specifically, optical medium 30aB may be a liquid crystal that exhibits birefringence. As one example, a liquid crystal with an ordinary index (no) of 1.5 and an extraordinary index (ne) of 1.7 is used. Irregular structure 30b is made of a resin having a refractive index of 1.5 as in Embodiment 1 described above.

Here, optical device 1B according to this variation was actually produced as an exemplary embodiment, and this device will be described hereinafter.

In the present exemplary embodiment, a transparent resin substrate made of PET was used as first substrate 10, and a first transparent substrate was produced by molding uneven structure 30b on portions of the resin substrate that correspond to first light-transmitting portions 31B, the uneven structure being configured such that a plurality of projections 30b1, each having a trapezoidal cross-section shape with a height of 10 μm, were formed of an acrylic resin (with a refractive index of 1.5) at equal intervals with clearance of 0 μm (with no clearance). Irregular structure 30b was formed in a stripe shape.

Next, second substrate 20 was used as a second transparent substrate (counter substrate), and optical device 1B was produced by forming a seal resin between the first and second transparent substrates to seal the first and second transparent substrate and, in this sealed condition, injecting a positive liquid crystal as optical medium 30aC between the first and second transparent substrates by vacuum injection. Here, a liquid crystal with an ordinary index (no) of 1.5 and an extraordinary index (ne) of 1.7 was used.

Optical device 1B produced in this way uses a liquid crystal that exhibits birefringence as optical medium 30aB and therefore can achieve both light distribution and transparency even in the presence of uneven structure 30b. However, the light transmittance of the optical device is reduced by approximately half.

For example when light is incident at an incident angle of 30° on optical device 1B produced as described above, 40% of light incident on first light-transmitting portion 31B is distributed to the ceiling surface at an elevation angle of 15°, and 40% of the remaining light travels in straight lines. In this way, light traveling in straight lines can reliably be obtained even in first light-transmitting portions 31B that include uneven structure 30b, because the liquid crystal exhibits birefringence. That is, only S waves in sunlight contribute to light distribution caused by total reflection at uneven structure 30b, and P waves in sunlight are not distributed and travel in straight lines.

As described thus far, optical device 1B according to this variation is capable of transmitting part of extraneous light incident on first light-transmitting portions 31B in straight lines while distributing the other part of the light. This allows an outside view to be seen from inside the room not only through second light-transmitting portions 32B but also through first light-transmitting portions 31B. Thus, the optical device can not only brighten the interior of the room hut also further improve its original function of offering an outside view as a window (transparency and openness), as compared with optical device 1 according to Embodiment 1 described above.

With optical device 1B according to this variation, the ratio of the area of first light-transmitting portion 31B to the total area of first light-transmitting portion 31B and second light-transmitting portion 32B in one cycle may be increased toward the upper part of the optical device in the vertical direction as in Embodiment 1 described above.

This configuration further increases transparency; thus allowing an outside view to be seen more clearly from inside the room and making the interior of the room brighter.

In the case where optical device 1B uses air as optical medium 30aB, instead of using a liquid crystal (i.e., in the case of optical device 1 according to Embodiment 1), 80% of light incident; at an incident angle of 30° on first light-transmitting portions 31B is distributed to the ceiling surface at an elevation angle of 20°, and light travelling in straight lines is not obtained. Thus, in the case where optical medium 30aB is air, an outside view cannot be seen from inside the room through first light-transmitting portions 31B and can only be seen from inside the room through second light-transmitting portions 32B.

### Embodiment 2

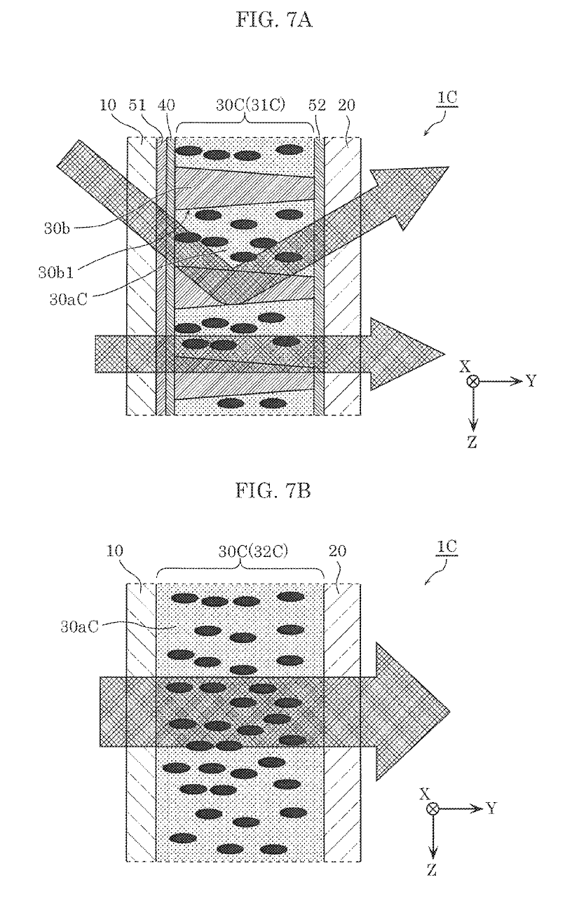

Next, optical device 1C according to Embodiment 2 will be described with reference to FIGS. 7A and 7B. FIG. 7A is a cross-sectional view of first light-transmitting portion 31C of optical control layer 30C in optical device 1C, and FIG. 7B is a cross-sectional view of second light-transmitting portion 32C of optical control layer 30C in optical device 1C.

Optical device 1C according to the present embodiment further includes a pair of electrodes 51 and 52 provided to sandwich first light-transmitting portions 31C, in addition to the constituent elements of optical device 1 according to Embodiment 1 described above.

Electrode 51 (first electrode) is formed on the surface of first substrate 10. Specifically, electrode 51 is formed on the surface of first substrate 10 that faces first light-transmitting portion 31C.

On the other hand, electrode (second electrode) 52 is formed on the surface of second substrate 20. Specifically, electrode 52 is formed on the surface of second substrate 20 that faces first light-transmitting portion 31C.

Electrodes 51 and 52 may for example be transparent conductive layers. Examples of the material for transparent conductive layers include transparent metal oxides such as indium tin oxide (ITO) and indium zinc oxide (IZO), conductor-containing resins that are resins containing a conductor such as silver nanowires or conductive particles, and metallic thin films such as silver thin films. Electrodes 51 and 52 may have a single-layer structure of such a material, or may have a laminated structure of such materials (e,g., a laminated structure of a transparent metal oxide layer and a metallic thin film).

Although optical device 1 according to Embodiment 1 described above uses air as optical medium 30a of first and second light-transmitting portions 31 and 32, optical device 1C according to the present embodiment uses a material that exhibits birefringence and electric field responsiveness as optical medium 30aC in first and second light-transmitting portions 31B and 32B of optical control layer 30B. Specifically, a liquid crystal including liquid crystal molecules may be used as optical medium 30aC. In the present embodiment, a negative liquid crystal is used as optical medium 30aC, the negative liquid crystal including rod-like liquid crystal molecules having a low dielectric constant in the major axial direction and a high dielectric constant in a direction perpendicular to the major axis.

Liquid crystals have a varying refractive index because the orientations of the liquid crystal molecules change with a change in electric field. Since first light-transmitting portion 31 is sandwiched between the pair of electrodes 51 and 52, an electric field is applied to first light-transmitting portion 31 when a voltage is applied to the pair of electrodes 51 and 52. The application of an electric field changes the orientations of liquid crystal molecules and changes the refractive index of first light-transmitting portion 31 in the direction of rays of light. That is, first light-transmitting portion 31 functions as a refractive index adjustment layer that is capable of adjusting a refractive index in a visible light range.

As one example, when uneven structure 30b has a refractive index of 1.5, a liquid crystal that exhibits birefringence with an ordinary index (no) of 1.5 and an extraordinary index (ne) of 1.7 may be used as optical medium 30aC. In this case, first light-transmitting portion 31 (optical medium 30aC) has a refractive index of 1.5 when no voltage is applied to electrodes 51 and 52. On the other hand, first light-transmitting portion 31 (optical medium 30aC) has a refractive index of 1.7 when a voltage is applied to electrodes 51 and 52. A difference (0.2) in refractive index between uneven structure 30b and optical medium 30aC (liquid crystal) during the application of a voltage allows the light incident on first light-transmitting portion 31 to be totally reflected at the interface between uneven structure 30b and optical medium 30aC and to be controlled to be distributed.

Note that the refractive index of first light-transmitting portion 31 (optical medium 30aC) can be changed between 1.5 and 1.7 by adjusting the value of the voltage applied to the pair of electrodes 51 and 52.

In the present embodiment that uses a negative liquid crystal, when no voltage is applied to the pair of electrodes 51 and 52 and therefore no electric field is applied to first light-transmitting portion 31 (optical medium 30aC), rod-like liquid crystal molecules are oriented in a direction parallel to the thickness direction of optical device 1C. That is, when no voltage is applied to the electrodes, the liquid crystal molecules are oriented vertically with respect to the main surfaces of first substrate 10 and second substrate 20.

Although the liquid crystal molecules are known to be oriented along the shape of uneven structure 30b, in the present embodiment the liquid crystal molecules in the uneven structure 30b are oriented vertically in the same manner as on the side of first substrate 10 because projections 30b1 of uneven structure 30b have a high aspect ratio of approximately 1 to 5.

When a voltage is applied to the pair of electrodes 51 and 52 and accordingly an electric field is applied to first light-transmitting portion 31 (optical medium 30aC), the rod-like liquid crystal molecules are oriented in the direction of arrangement of projections 30b1, i.e., in a direction orthogonal to the thickness direction of optical device 1. That is, the liquid crystal molecules are oriented in parallel with the main surfaces of first substrate 10 and second substrate 20 during the application of a voltage.

Example of Use and Advantageous Effect of Optical Device

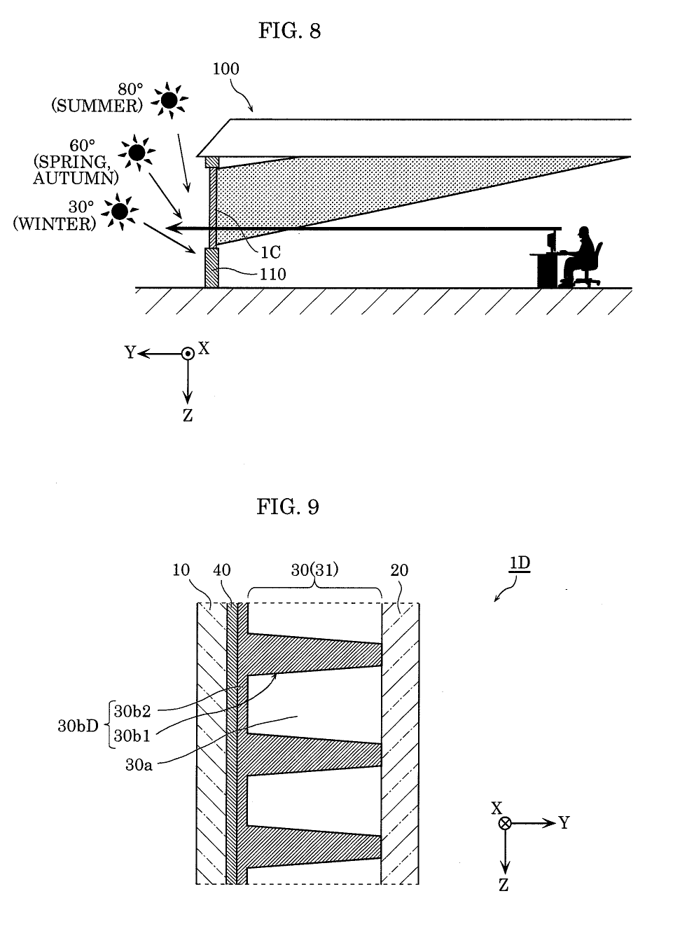

Next, an example of use of optical device 1C according to Embodiment 2 will be described with reference to FIG. 8. FIG. 8 illustrates an example of use of optical device 1C according to Embodiment 2.

As illustrated in FIG. 8, optical device 1C can be used as, for example, a window of building 100 as in Embodiment 1. Specifically, optical device 1C can be attached to an opening of exterior wall 110 of building 100. In this case, optical device 1C is mounted in a posture in which the main surface of first substrate 10 is parallel to the vertical direction (Z axial direction), i.e., in an upright posture.

Although a detailed structure of optical device 1C is not shown in FIG. 8, optical device 1C is disposed such that first substrate 10 is on the outside of the room and second substrate 20 is on the inside of the room.

Optical device 1C configured in this way according to the present embodiment has a structure similar to that of optical device 1 according to Embodiment 1 described above, but the present embodiment differs from Embodiment 1 described above in that optical medium 30aC is a liquid crystal and its orientation is controlled by the pair of electrodes 51 and 52. That is, an active type optical device capable of transmitting incident light without bending the light and capable of bending and transmitting incident light can be achieved by controlling refractive index matching between uneven structure 30b and optical medium 30aC (liquid crystal) by an electric field.

Here, optical device 1C according to the present embodiment was actually produced as an exemplary embodiment, and this device will be described hereinafter.

In the present exemplary embodiment, a transparent resin substrate made of PET was used as first substrate 10, and a film having a thickness of 100 nm was formed as electrode 51 on the resin substrate. Then, a first transparent substrate was produced by molding uneven structure 30b on portions of the resin substrate that correspond to first light-transmitting portions 31C and where electrode 51 was formed, the uneven structure being configured such that a plurality of projections 30b1, each having a trapezoidal cross-sectional shape with a height of 10 μm, were formed of an acrylic resin (with a refractive index of 1.5) at equal intervals with clearance of 0 μm (with no clearance). Irregular structure 30b was formed in a stripe shape.

Next, second substrate 20 where electrode 52 was formed was used as a second transparent substrate (counter substrate), and optical device 1C was produced by forming a seal resin between the first and second transparent substrates to seal the first and second transparent substrates and, in this sealed condition, injecting a negative liquid crystal as optical medium 30aC between the first and second transparent substrates by vacuum injection. Here, a liquid crystal with an ordinary index (no) of 1.5 and an extraordinary index (ne) of 1.7 was used.

Optical device 1C produced in this way can change the refractive index of optical medium 30aC by applying a voltage to optical medium 30aC crystal) via the pair of electrodes 51 and 52. Thus, optical device 1C can control the distribution of light incident on optical device 1C.

For example when a voltage is not applied to the pair of electrodes 51 and 52 and light is incident at an incident angle of 30° on optical device 1C produced as described above, the light incident on optical device 1C travels in straight lines through optical device 1C and is not distributed.

On the other hand, when a voltage of 20V is applied to optical medium 30aC from the voltage applied to the pair of electrodes 51 and 52, the refractive index of optical medium 30aC (liquid crystal) changes. Thus, when light is incident at an incident angle of 30° on optical device 1C, 40% of the light incident on optical device 1C is totally reflected by first light-transmitting portions 31C and distributed toward the ceiling surface at au elevation angle of 15°, and 40% of the remaining light travels in straight lines. In this way, light travelling in straight lines can reliably be obtained in the present embodiment because the liquid crystal exhibits birefringence. That is, only S waves in sunlight contribute to light distribution caused by total reflection at uneven structure 30b, and P waves in sunlight are not distributed and travel in straight lines.

Summary

As described thus far, optical device 1C according to the present embodiment uses a liquid crystal that exhibits birefringence and electric field responsiveness as optical medium 30aC that is in contact with uneven structure 30b. Thus, an active-type optical device capable of transmitting extraneous light and capable of bending the travel direction of extraneous light can be achieved by controlling refractive index matching between uneven structure 30b and optical medium 30aC via a change in electric field caused by the application of a voltage to electrodes 51 and 52.

Moreover, optical device 1C according to the present embodiment can transmit part of extraneous light incident on optical device 1C in straight lines while distributing the other part of the light during the application of a voltage. Thus, an outside view can also be seen from inside the room through first light-transmitting portion 31C. As a result, an outside view can be seen from inside the room not only through second light-transmitting portion 32C but also through first light-transmitting portion 31C.

Accordingly, optical device 1C according to the present embodiment can not only brighten the interior of the room but also further improve its original function of offering an outside view as a window (transparency and openness), as compared with optical device 1 according to Embodiment 1.

With optical device 1C according to the present embodiment, the ratio of the area of first light-transmitting portion 31C to the total area of first light-transmitting portion 31C and second light-transmitting portion 32C in one cycle may be increased toward the upper part of the optical device in the vertical direction as in Embodiment 1.

This further improves transparency, thus not only allowing an outside view to be seen more clearly from inside the room but also brightening the interior of the room.

Optical device 1C according to the present embodiment can be used to reduce power requirements by taking in sunlight at a solar altitude of 30° to 60° into the room. This will be described hereinafter with reference to FIG. 8.

In general, the magnitude of the birefringence of liquid crystals is 0.2, or approximately 0.3 at the maximum. Thus, a difference in refractive index between uneven structure 30b and optical medium 30aC is in the range of approximately 0.2 to 0.3.

Here, as illustrated in FIG. 8, the culmination altitude of the sun is approximately 30° at the winter solstice, approximately 55° at the spring and autumnal equinoxes, and approximately 80° at the summer solstice, and the range of solar altitude (altitude range) is 50° in the case of Tokyo. If the culmination altitude gets higher, the amount of sunlight incident on the vertical surface of the window decreases in the first place, and there is a small effect of reducing power requirements for lighting equipment by taking in sunlight into the interior of the room. On the other hand, if sunlight can effectively be taken in into the interior of the room when the solar altitude is in the range of 30° to 60°, the effect of reducing power requirements for lighting equipment is substantial. That is, power requirements for lighting equipment can be reduced enough if sunlight can be taken in into the interior of the room with an altitude range of at least 30°.

Other Variations

While the above has been a description of embodiments and variations of optical devices according to the present invention, the present invention is not intended to be limited to the embodiments and variations described above.

For example, although projections 30b1 of uneven structure 30b according to the embodiments and variations described above are isolated from one another; they may be coupled to one another. Specifically, as in optical device 1D illustrated in FIG. 9, uneven structure 30b1) may be configured by thin layer 30b2 formed on the side facing first substrate 10 (on the side facing contact layer 40) and a plurality of projections 30b1 that protrude from thin layer 30b2. Thin layer 30b2 may be formed intentionally, or may be a residual film when forming projections 30b1. In this case, thin layer 30b2 (residual film) may have a thickness of 1 μm or less. Although not shown, thin layer 30b2 may be formed in not only regions corresponding to first light-transmitting portions 31 but also regions corresponding to both first light-transmitting portions 31 and second light-transmitting portions 32.

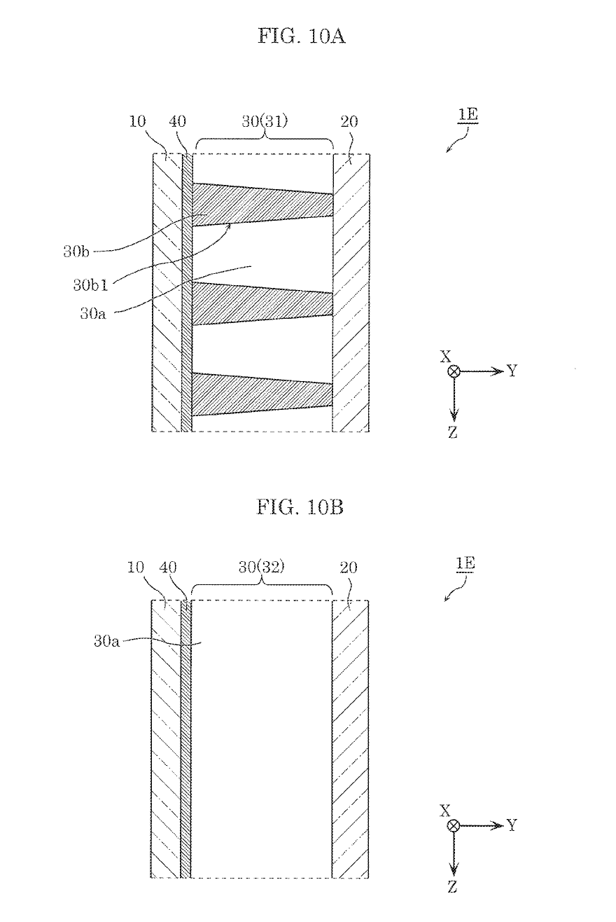

Although contact layer 40 according to the embodiments and variations described above is formed in only regions corresponding to first light-transmitting portions 31 and 31A to 31C that include uneven structure 30b, the present invention is not limited to this configuration. For example, as in optical device 1E illustrated in FIGS. 10A and 10B, contact layer 40 may be formed in regions that correspond to both first light-transmitting portions 31 and second light-transmitting portions 32. Specifically, contact layer 40 may be formed on the entire surface of first substrate 10. Although not shown, thin layer 30b2 described above may be further formed on the surface of contact layer 40 that corresponds to second light-transmitting portions 32.

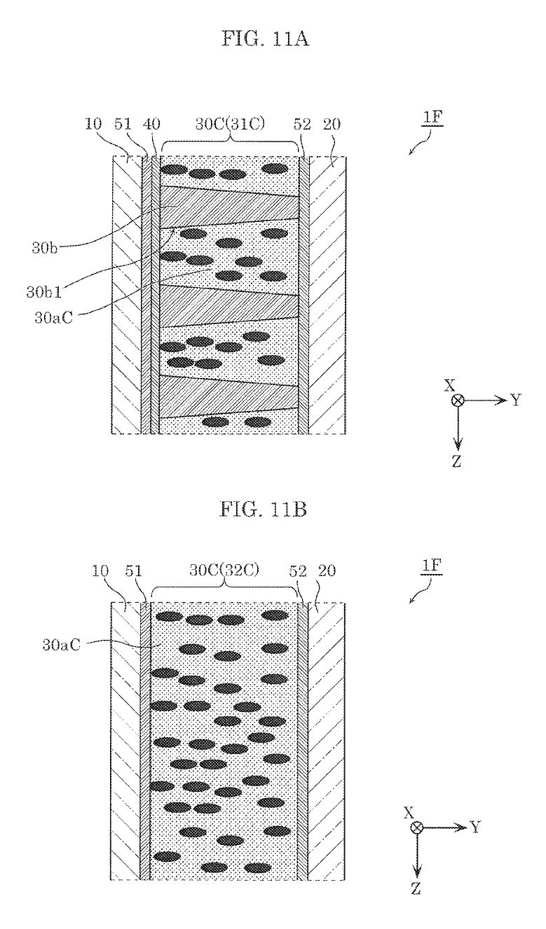

Although electrodes 51 and 52 according to Embodiment 2 described above are formed in only the regions corresponding to first light-transmitting portions 30 that include uneven structure 30b so as to sandwich only first light-transmitting portions 31C, the present invention is not limited to this configuration. For example, as in optical device 1F illustrated in FIGS. 11A and 11B, electrodes 51 and 52 may be formed in regions that corresponds to both first light-transmitting portions 31 and second light-transmitting portions 32. Specifically, electrode 51 may be formed on the entire surface of first substrate 10 and electrode 52 may be formed on the entire surface of second substrate 20 so that electrodes 51 and 52 sandwich both first light-transmitting portions 31C and second light-transmitting portions 32C. Although not shown, the layer to be formed on the surface of electrode 51 that corresponds to second light-transmitting portions 32 may be contact layer 40 or may be thin layer 30b2 as described above.

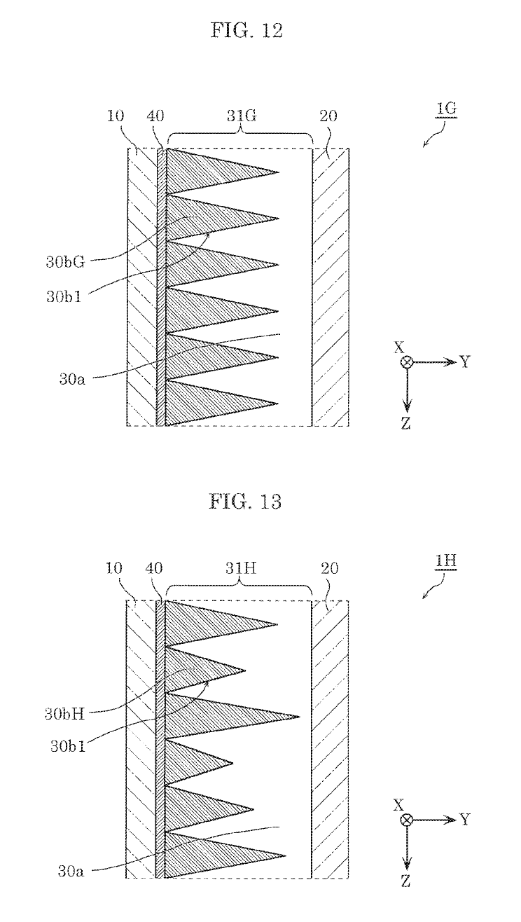

Although each projection 30b1 according to the embodiments and variations described above has an approximately quadrangular prism shape that is long and trapezoidal in cross section, the present invention is not limited to this example. As another example, as in optical device 1G illustrated in FIG. 12, each projection 30b1 of uneven structure 30bG in first light-transmitting portion 31G may have an approximately triangular prism shape that is long and triangular in cross section. In this case, each projection 30b1 has a cross-sectional shape (triangular shape) with a height of 100 nm to 100 μm and an aspect ratio (height/base) of approximately 1 to 5. The interval (pitch) between vertices of adjacent projections 30b1 is for example in the range of 100 μm to 100 μm. Note that the height, aspect ratio, and pitch of projections 30b1 are not limited to these ranges, and the cross-sectional shape of projections 30b1 is not limited to a triangle or a trapezoid.

Although projections 30b1 according to the embodiments and variations described above have a constant height, the present invention is not limited to this example. For example, as in, optical device 1H illustrated in FIG. 13, a plurality of projections 30b1 of uneven structure 30bH in first light-transmitting portion 31H may have random heights. The random heights of projections 30b1 reduces the possibility that the light emitted from optical device 1E may look like light in rainbow colors. That is, the random heights of projections 30b1 averages the wavelengths of slight diffraction rays and scattering rays occurring at uneven interfaces and reduces the possibility of coloring of the emitted light. The possibility that the light emitted from optical device may look like light in rainbow colors can also be reduced by randomizing the alignment (pitch) of projections 30b1, instead of randomizing the heights of projections 30b1. Examples of the randomization technique include error distribution and exponential distribution.

Although projections 30b1 of uneven structure 30b according to the embodiments and variations described above are configured by forming long quadrangular prisms, each extending in the X axial direction across a plurality of unit regions of first light-transmitting portion 31, in a stripe shape, the present invention is not limited to this configuration. For example, a plurality of projections 30b1 may be scattered like dots.

Although Variation 2 of Embodiment 1 described above uses a positive liquid crystal as optical medium 30aB of optical control layer 30B, a negative liquid crystal may be used instead. On the contrary, although Embodiment 2 described above uses a negative liquid crystal as optical medium 30aC of optical control layer 30C, a positive liquid crystal may be used instead.

The liquid crystals according to Variation 2 of Embodiment 1 and Embodiment 2 described above may for example be nematic liquid crystals or cholesteric liquid crystals. In this case, a twisted nematic liquid crystal (TN liquid crystal) may be used as a nematic liquid crystal.

Alternatively, the liquid crystals may be liquid crystals containing macromolecules such as a polymeric structure. The polymeric structure is, for example, a mesh-like structure and allows adjustment of refractive index by disposing liquid crystal molecules in the polymeric structure (between meshes). Examples of the liquid crystal material containing macromolecules include polymer dispersed liquid crystals (PDLCs) and polymer network liquid crystals (PNLCs).

As another alternative, the liquid crystals may also be liquid crystals including a memory such as ferroelectric liquid crystals (FLCs). In this case, the condition when an electric field is applied to the first light-transmitting portions (optical medium) is maintained because the first light-transmitting portions include a memory.

Although the optical medium of the optical control layer according to the embodiments and variations described above is one of air, a resin with light transmission properties, and a liquid crystal, the present invention is not limited to this example. For example, the optical medium of the optical control layer is not limited to a fluid or a solid and may be a liquid such as a refractive index oil, as long as the material for the optical medium has a different refractive index from that of an uneven structure that is in contact with the optical medium.

Although sunlight is given as an example of the light incident on the optical devices in the embodiments and variations described above, the present invention is not limited to this example. For example, the light incident on the optical devices may be a light emitting device such as lighting equipment.

Although the optical devices are used as the very windows of building 100 in the embodiments and variations described above, the optical devices may be attached to a window. In this case, the optical device may be attached to the surface of a window on the inside of the room, or may be attached to the surface of the window on the outside of the room. Alternatively, the optical devices may be mounted to a different portion other than exterior wall 110 of building 100, and may be attached to, for example, an interior wall or partition of building 100. The application of the optical devices is not limited to windows of buildings, and may be used as, for example, a window of a vehicle.

Note that other embodiments are also intended to be included within the scope of the present invention, such as those obtained by making various modifications conceived by those skilled in the art to the above-described embodiments and variations, and those achieved by arbitrarily combining constituent elements and functions of the above-described embodiments and variations without departing from the scope of the invention of the present invention.

### REFERENCE MARKS IN THE DRAWINGS

1, 1A, 1B, 1C, 1D, 1E, 1F, 1G, 1H optical device

10 first substrate

20 second substrate

30 optical control layer

30a, 30aA, 30aB, 30aC optical medium

30b, 30bD, 30bG, 30bH uneven structure

30b1 projection

31, 31A, 31B, 31C, 31G, 31H first light-transmitting portion

32, 32A, 32B, 32C second light-transmitting portion

51, 52 electrode

1. An optical device comprising:
a first substrate having light transmission properties;
a second substrate opposing the first substrate and having light transmission properties; and
an optical control layer disposed between the first substrate and the second substrate and including a first light-transmitting portion and a second light-transmitting portion, the first light-transmitting portion including an optical medium and an uneven structure, and the second light-transmitting portion including only the optical medium out of the optical medium and the uneven structure,
wherein the optical medium and the uneven structure have different refractive indices,
in a plan view, the first light-transmitting portion and the second light-transmitting portion are repeatedly arranged in one direction, and an area of repetition of at least one of the first light-transmitting portion and the second light-transmitting portion varies in the one direction,
the first light-transmitting portion and the second light-transmitting portion are each a region configured by a combination of a plurality of unit regions, each having a square shape in a plan view, and
the first light-transmitting portion bends incident light in a rebound direction.

2. The optical device according to claim 1,
wherein the one direction is a vertical direction,
in a plan view, a ratio of an area of the first light-transmitting portion to a total area of the first light-transmitting portion and the second light-transmitting portion in a cycle consisting of one first light-transmitting portion and one second light-transmitting portion varies in the vertical direction, and
the ratio increases toward an upper part of the optical device in the vertical direction when the optical device is disposed with a main surface of the first substrate being parallel to the vertical direction.

3. The optical device according to claim 1,
wherein the optical medium is a liquid crystal.

4. The optical device according to claim 3, further comprising:
a pair of electrodes provided to sandwich the first light-transmitting portion.

5. The optical device according to claim 4,
wherein the uneven structure includes a plurality of projections, and
a liquid crystal molecule contained in the liquid crystal is oriented in a direction parallel to a direction of arrangement of the plurality of projections.

6. The optical device according to claim 5,
wherein the optical medium includes a liquid crystal, and
a liquid crystal molecule contained in the liquid crystal is oriented in a direction parallel to a direction of thickness of the optical device.

7. The optical device according to claim 1,
wherein the optical medium is air or a resin having light transmission properties.

8. The optical device according to claims 1,
wherein the uneven structure includes a plurality of projections, and
the plurality of projections each have a trapezoidal or approximately triangular cross-sectional shape.

9. The optical device according to claims 1,
wherein the plurality of projections have a stripe shape.
